(19) United States
(12) Patent Application Publication
(10) Pub. No.: US 2016/0286395 A1
(43) Pub. Date: Sep. 29, 2016

(54) APPARATUS, SYSTEM AND METHOD OF SECURING COMMUNICATION BETWEEN WIRELESS DEVICES

(71) Applicant: INTEL CORPORATION, Santa Clara, CA (US)

(72) Inventors: Farid Adrangi, Lake Oswego, OR (US); Alexandre S. Stojanovski, Paris (FR); Emily H. Qi, Camas, WA (US); Ganesh Venkatesan, Hillsboro, OR (US)

(21) Appl. No.: 14/749,894

(22) Filed: Jun. 25, 2015

Related U.S. Application Data
(60) Provisional application No. 62/137,370, filed on Mar. 24, 2015.

(51) Int. Cl. H04W 12/06; H04L 9/30; H04L 29/06

(52) U.S. Cl. CPC H04W 12/06; H04L 63/12; H04L 63/062; H04L 9/30

(57) ABSTRACT

Some demonstrative embodiments include apparatuses, systems and/or methods of securing communication between awareness networking devices. For example, an apparatus may include logic and circuitry configured to cause a first Neighbor Awareness Networking (NAN) device to discover a second NAN device according to a NAN discovery scheme; transmit to the second NAN device a first message signed with a signing key of the first NAN device, the first message comprising a first public security key of the first NAN device and a first public verification key of the first NAN device; process a second message received from the second NAN device, the second message signed with a signing key of the second NAN device and comprising a second public security key of the second NAN device and a second public verification key of the second NAN device; determine a session security key, based on the first and second public security keys; and establish a secure session with the second NAN device using the session security key.

### CROSS REFERENCE

This application claims the benefit of and priority from U.S. Provisional Patent Application No. 62/137,370 entitled “Apparatus, System and Method of Securing Communication Between Awareness Networking Devices”, filed Mar. 24, 2015, the entire disclosure of which is incorporated herein by reference.

### TECHNICAL FIELD

Embodiments described herein generally relate to securing communication between awareness networking devices.

### BACKGROUND

Awareness networking, for example, Neighbor Awareness Networking (NAN), may be implemented by devices, for example, Wireless Fidelity (WiFi) devices, to enable, for example, device/service discovery in their close proximity.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative embodiments.

FIG. 2 is a schematic illustration of operations and communications of a service registration, in accordance with some demonstrative embodiments.

FIG. 3 is a schematic illustration of operations and communications of establishing a secure session, in accordance with some demonstrative embodiments.

FIG. 4 is a schematic illustration of operations and communications of establishing a secure session, in accordance with some demonstrative embodiments.

FIG. 5 is a schematic flow-chart illustration of a method of securing communication between wireless devices, in accordance with some demonstrative embodiments.

FIG. 6 is a schematic illustration of a product, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some embodiments may be used in conjunction with devices and/or networks operating in accordance with existing Wireless Fidelity (WiFi) Alliance (WFA) Specifications (including Wi-Fi Neighbor Awareness Networking (NAN) Technical Specification, Version 1.0, May 1, 2015) and/or future versions and/or derivatives thereof, devices and/or networks operating in accordance with existing WFA Peer-to-Peer (P2P) specifications (WiFi P2P technical specification, version 1.5, Aug. 4, 2014) and/or future versions and/or derivatives thereof, devices and/or networks operating in accordance with existing Wireless-Gigabit-Alliance (WGA) specifications (Wireless Gigabit Alliance, Inc WiGig MAC and PHY Specification Version 1.1, April 2011, Final specification) and/or future versions and/or derivatives thereof, devices and/or networks operating in accordance with existing IEEE 802.11 standards (IEEE 802.11-2012, IEEE Standard for Information technology—Telecommunications and information exchange between systems Local and metropolitan area networks—Specific requirements Part 11: Wireless LAN Medium Access Control (MAC) and Physical Layer (PHY) Specifications, Mar. 29, 2012; IEEE802.11ac-2013 (“IEEE P802.11ac-2013, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 4: Enhancements for Very High Throughput for Operation in Bands below 6 GHz”, December, 2013); IEEE 802.11ad (“IEEE P802.11ad-2012, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band”, 28 Dec. 2012); and/or IEEE-802.11REVmc (“IEEE 802.11-REVmc™/D3.0, June 2014 draft standard for Information technology—Telecommunications and information exchange between systems Local and metropolitan area networks Specific requirements; Part 11: Wireless LAN Medium Access Control (MAC) and Physical Layer (PHY) Specification”)) and/or future versions and/or derivatives thereof, devices and/or networks operating in accordance with existing cellular specifications and/or protocols, e.g., 3rd Generation Partnership Project (3GPP), 3GPP Long Term Evolution (LTE) and/or future versions and/or derivatives thereof, units and/or devices which are part of the above networks, and the like.

Some embodiments may be used in conjunction with one way and/or two-way radio communication systems, cellular radio-telephone communication systems, a mobile phone, a cellular telephone, a wireless telephone, an Internet of things (IoT) device, a sensor device, a wearable device, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device.

Some demonstrative embodiments may be used in conjunction with a WLAN, e.g., a wireless fidelity (WiFi) network. Other embodiments may be used in conjunction with any other suitable wireless communication network, for example, a wireless area network, a “piconet”, a WPAN, a WVAN and the like.

The term “antenna”, as used herein, may include any suitable configuration, structure and/or arrangement of one or more antenna elements, components, units, assemblies and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include, for example, a phased array antenna, a single element antenna, a set of switched beam antennas, and/or the like.

The phrase “peer to peer (PTP) communication”, as used herein, may relate to device-to-device communication over a wireless link (“peer-to-peer link”) between devices. The PTP communication may include, for example, a WiFi Direct (WFD) communication, e.g., a WFD Peer to Peer (P2P) communication, wireless communication over a direct link within a QoS basic service set (BSS), a tunneled direct-link setup (TDLS) link, a STA-to-STA communication in an independent basic service set (IBSS), or the like.

Some demonstrative embodiments are described herein with respect to WiFi communication. However, other embodiments may be implemented with respect to any other communication scheme, network, standard and/or protocol.

Some demonstrative embodiments are described herein with respect to Neighbor Awareness Networking (NAN) communication. However, other embodiments may be implemented with respect to any other communication scheme, network, standard and/or protocol, for example, a direct communication network, a peer to peer communication network, a one-to-one communication network, a Proximity Services (ProSe) direct communication, and the like.

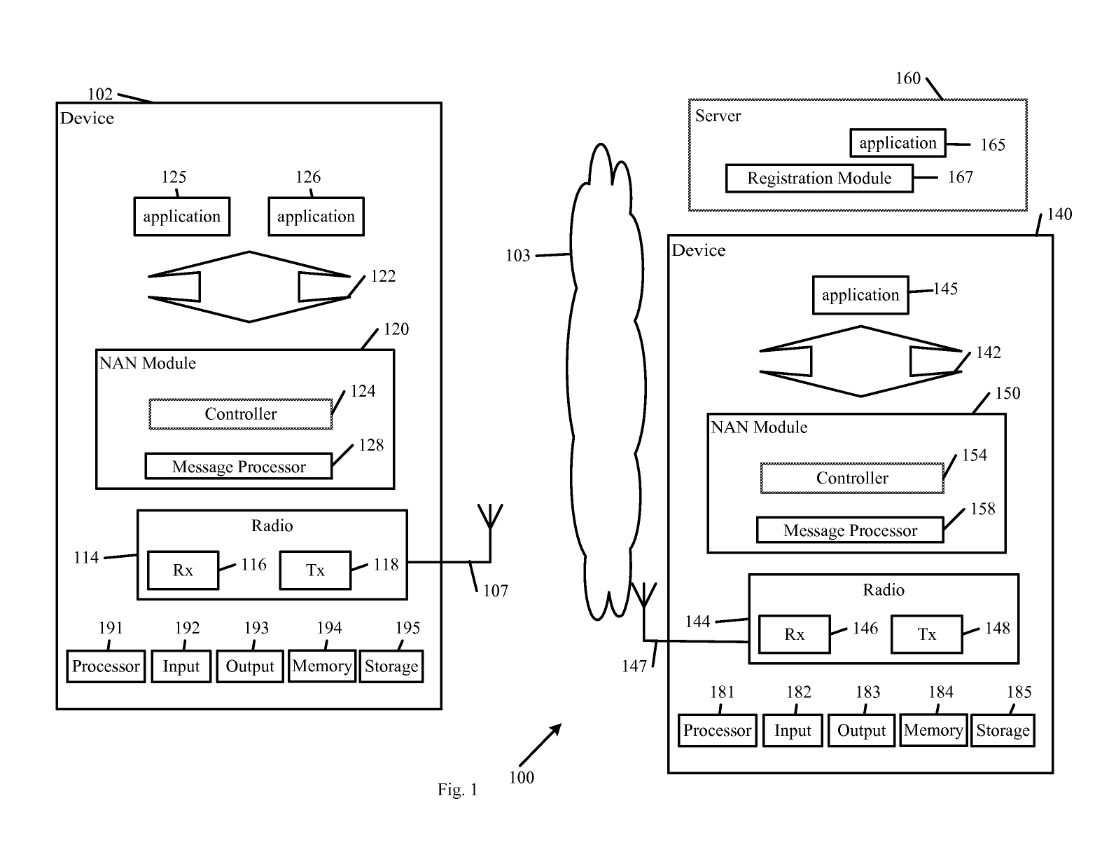

Reference is now made to FIG. 1, which schematically illustrates a block diagram of a system 100, in accordance with some demonstrative embodiments.

As shown in FIG. 1, in some demonstrative embodiments system 100 may include a wireless communication network including one or more wireless communication devices, e.g., wireless communication device 102 and/or device 140.

In some demonstrative embodiments, wireless communication device 102 and/or device 140 may include, for example, a UE, an MD, a STA, an AP, a PC, a desktop computer, a mobile computer, a laptop computer, an Ultrabook™ computer, a notebook computer, a tablet computer, a server computer, a handheld computer, a handheld device, an Internet of Things (IoT) device, a sensor device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player, or the like.

In some demonstrative embodiments, device 102 and/or device 140 may include, or may perform the functionality of an Access Point (AP) STA.

In some demonstrative embodiments, device 102 and/or device 140 may include, or may perform the functionality of, a non-AP STA.

In one example, both of devices 102 and 140 may include, or may perform the functionality of, a non-AP STA.

In another example, one of devices 102 and 140 may include, or may perform the functionality of, an AP STA, and another one of devices 102 and 140 may include, or may perform the functionality of, a non-AP STA. For example, device 102 may perform the functionality of an AP, and device 140 may perform the functionality of a non-AP STA. In another example, device 140 may perform the functionality of an AP STA, and device 102 may perform the functionality of a non-AP STA.

In yet another example, both of devices 102 and 140 may include, or may perform the functionality of, an AP STA.

In some demonstrative embodiments, an AP STA may include, or may perform the functionality of, for example, a router, a PC, a server, a Hot-Spot and/or the like.

In some demonstrative embodiments, the non-AP STA may include, for example, a Smartphone, a tablet, a notebook, a sensor device, a UE, a mobile device, an IoT device, and/or the like.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains a station (STA), e.g., one STA, and provides access to distribution services, via the wireless medium (WM) for associated STAs. The AP may perform any other additional or alternative functionality.

In one example, a non-access-point (non-AP) station (STA) may include a STA that is not contained within an AP. The non-AP STA may perform any other additional or alternative functionality.

In some demonstrative embodiments, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Device 102 and/or device 140 may optionally include other suitable hardware components and/or software components. In some demonstrative embodiments, some or all of the components of one or more of device 102 and/or device 140 may be enclosed in a common housing or packaging, and may be interconnected or operably associated using one or more wired or wireless links. In other embodiments, components of one or more of device 102 and/or device 140 may be distributed among multiple or separate devices.

Processor 191 and/or processor 181 includes, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 executes instructions, for example, of an Operating System (OS) of device 102 and/or of one or more suitable applications. Processor 181 executes instructions, for example, of an Operating System (OS) of device 140 and/or of one or more suitable applications.

Input unit 192 and/or input unit 182 includes, for example, a keyboard, a keypad, a mouse, a touch-screen, a touch-pad, a track-ball, a stylus, a microphone, or other suitable pointing device or input device. Output unit 193 and/or output unit 183 includes, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

Memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 includes, for example, a hard disk drive, a floppy disk drive, a Compact Disk (CD) drive, a CD-ROM drive, a DVD drive, or other suitable removable or non-removable storage units. Memory unit 194 and/or storage unit 195, for example, may store data processed by device 102. Memory unit 184 and/or storage unit 185, for example, may store data processed by device 140.

In some demonstrative embodiments, wireless communication device 102 and/or device 140 may be capable of communicating content, data, information and/or signals via a wireless medium (WM) 103. In some demonstrative embodiments, wireless medium 103 may include, for example, a radio channel, a cellular channel, a Global Navigation Satellite System (GNSS) Channel, an RF channel, a Wireless Fidelity (WiFi) channel, an IR channel, a Bluetooth (BT) channel, and the like.

In some demonstrative embodiments, wireless communication medium 103 may include a wireless communication channel over a 2.4 Gigahertz (GHz) frequency band, a 5 GHz frequency band, a millimeterWave (mmWave) frequency band, e.g., a 60 GHz frequency band, a Sub 1 Gigahertz (S1G) band, and/or any other frequency band.

In some demonstrative embodiments, device 102 and/or device 140 may include one or more radios including circuitry and/or logic to perform wireless communication between devices 102, 140 and/or one or more other wireless communication devices. For example, device 102 may include a radio 114, and/or device 140 may include a radio 144.

In some demonstrative embodiments, radios 114 and/or 144 may include one or more wireless receivers (Rx) including circuitry and/or logic to receive wireless communication signals, RF signals, frames, blocks, transmission streams, packets, messages, data items, and/or data. For example, radio 114 may include a receiver 116, and/or radio 144 may include a receiver 146.

In some demonstrative embodiments, radios 114 and/or 144 may include one or more wireless transmitters (Tx) including circuitry and/or logic to send wireless communication signals, RF signals, frames, blocks, transmission streams, packets, messages, data items, and/or data. For example, radio 114 may include a transmitter 118, and/or radio 144 may include a transmitter 148.

In some demonstrative embodiments, radios 114 and/or 144 may be configured to communicate over a 2.4 GHz band, a 5 GHz band, a mmWave band, a S1G band, a cellular band, and/or any other band.

In some demonstrative embodiments, radios 114 and/or 144 may include circuitry and/or logic, modulation elements, demodulation elements, amplifiers, analog to digital and digital to analog converters, filters, and/or the like. In one example, radios 114 and/or 144 may include or may be implemented as part of a wireless Network Interface Card (NIC), and the like.

In some demonstrative embodiments, radios 114 and/or 144 may include, or may be associated with, one or more antennas 107 and/or 147, respectively.

In one example, device 102 may include a single antenna 107. In another example, device 102 may include two or more antennas 107.

In one example, device 140 may include a single antenna 147. In another example, device 140 may include two or more antennas 147.

Antennas 107 and/or 147 may include any type of antennas suitable to transmit and/or receive wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. Antennas 107 and/or 147 may include, for example, antennas suitable for directional communication, e.g., using beamforming techniques. For example, antennas 107 and/or 147 may include a phased array antenna, a multiple element antenna, a set of switched beam antennas, and/or the like. In some embodiments, antennas 107 and/or 147 may implement transmit and receive functionalities using separate transmit and receive antenna elements. In some embodiments, antennas 107 and/or 147 may implement transmit and receive functionalities using common and/or integrated transmit/receive elements.

In some demonstrative embodiments, wireless communication device 102 and/or wireless communication device 140 may form, and/or may communicate as part of, a wireless local area network (WLAN).

In some demonstrative embodiments, wireless communication device 102 and/or wireless communication device 140 may form, and/or may communicate as part of, a WiFi network.

In some demonstrative embodiments, wireless communication device 102 and/or wireless communication device 140 may form, and/or may communicate as part of, a WiFi Direct (WFD) network, e.g., a WiFi direct services (WFDS) network, and/or may perform the functionality of one or more WFD devices.

In one example, device 102 and/or device 140 may include, or may perform the functionality of a WiFi Direct device.

In some demonstrative embodiments, wireless communication device 102 and/or wireless communication device 140 may be capable of performing awareness networking communications, for example, according to an awareness protocol, e.g., a WiFi aware protocol, and/or any other protocol, e.g., as described below.

In some demonstrative embodiments, wireless communication device 102 and/or wireless communication device 140 may be capable of forming, and/or communicating as part of, a Neighbor Awareness Networking (NAN) network, e.g., a WiFi NAN or WiFi Aware network, and/or may perform the functionality of one or more NAN devices (“WiFi aware devices”).

In some demonstrative embodiments, wireless communication medium 103 may include a direct link, for example, a PTP link, e.g., a WiFi direct P2P link or any other PTP link, for example, to enable direct communication between device 102 and device 140.

In some demonstrative embodiments, wireless communication device 102 and/or wireless communication device 140 may perform the functionality of WFD P2P devices. For example, device 102 and/or device 140 may be able to perform the functionality of a P2P client device, and/or P2P group Owner (GO) device.

In one example, device 102 and/or device 140 may include, or may perform the functionality of a ProSe direct communication device or STA.

In other embodiments, wireless communication device 102 and/or wireless communication device 140 may form, and/or communicate as part of, any other network and/or perform the functionality of any other wireless devices or stations.

In some demonstrative embodiments, device 102 and/or device 140 may include one or more applications configured to provide, share, and/or to use one or more services, e.g., a social application, a file sharing application, a media application and/or the like, for example, using an awareness network, NAN network (“WiFi Aware network”), a PTP network, a P2P network, WFD network, or any other network.

In some demonstrative embodiments, device 102 may execute an application 125 and/or an application 126. In some demonstrative embodiments, device 140 may execute an application 145.

In some demonstrative embodiments, device 102 and/or device 140 may include a NAN module configured to control one or more NAN functionalities of device 102 and/or device 140, for example, one or more functionalities of communication, e.g., awareness networking communications, WiFi Aware (NAN) communication and/or any other communication, between device 102 and/or device 140 and/or other devices, one or more operations, e.g., NAN operations, and/or any other functionality and/or operations, e.g., as described below. For example, device 102 may include a NAN module 120; and/or device 140 may include a NAN module 150.

In some demonstrative embodiments, device 102 and/or device 140 may include a controller configured to control one or more functionalities of device 102 and/or device 140, for example, one or more functionalities of communication, e.g., awareness networking communications, WiFi Aware (NAN) communication and/or any other communication, between device 102 and/or device 140 and/or other devices, one or more operations, e.g., NAN operations, and/or any other functionality and/or operations, e.g., as described below. For example, device 102 may include a controller 124, and/or device 140 may include a controller 154.

In some demonstrative embodiments, controllers 124 and/or 154 may be configured to perform one or more functionalities, communications, operations and/or procedures between wireless communication device 102 and/or wireless communication device 140, and/or one or more other devices, e.g., as described below.

In some demonstrative embodiments, controllers 124 and/or 154 may include circuitry and/or logic, e.g., one or more processors including circuitry and/or logic, memory circuitry and/or logic, and/or any other circuitry and/or logic, configured to perform the functionality of controllers 124 and/or 154. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause a wireless device, e.g., device 102, and/or a wireless station, e.g., a wireless STA implemented by device 102, to perform one or more operations, communications and/or functionalities, e.g., as described herein.

In one example, controller 154 may include circuitry and/or logic, for example, one or more processors including circuitry and/or logic, to cause a wireless device, e.g., device 140, and/or a wireless station, e.g., a wireless STA implemented by device 140, to perform one or more operations, communications and/or functionalities, e.g., as described herein.

In one example, controllers 124 and/or 154 may perform one or more functionalities of a NAN engine, e.g., a NAN discovery engine (DE), for example to process one or more service queries and/or responses, e.g., from applications and/or services on device 102 and/or device 140, and/or one or more other devices.

In some demonstrative embodiments, device 102 may include at least one interface 122 to interface between controller 124 and applications 125 and/or 126; and/or device 140 may include at least one interface 142 to interface between controller 154 and application 145.

In one example, interface 122 may include an Application Programming Interface (API), e.g., a NAN API, for example, to receive one or more service queries and/or responses, e.g., from applications 125, 126 and/or from one or more other services and/or applications on device 102.

In one example, interface 142 may include an API, e.g., a NAN API, for example, to receive one or more service queries and/or responses, e.g., from application 145 and/or from one or more other services and/or applications on device 140.

In some demonstrative embodiments, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below. In one example, message processor 128 may be configured to process transmission of one or more messages from a wireless station, e.g., a wireless STA implemented by device 102; and/or message processor 128 may be configured to process reception of one or more messages by a wireless station, e.g., a wireless STA implemented by device 102.

In some demonstrative embodiments, device 140 may include a message processor 158 configured to generate, process and/or access one or messages communicated by device 140.

In one example, message processor 158 may be configured to generate one or more messages to be transmitted by device 140, and/or message processor 158 may be configured to access and/or to process one or more messages received by device 140, e.g., as described below. In one example, message processor 158 may be configured to process transmission of one or more messages from a wireless station, e.g., a wireless STA implemented by device 140; and/or message processor 158 may be configured to process reception of one or more messages by a wireless station, e.g., a wireless STA implemented by device 140.

In some demonstrative embodiments, message processors 128 and/or 158 may include circuitry and/or logic, e.g., processor circuitry and/or logic, memory circuitry and/or logic, Media-Access Control (MAC) circuitry and/or logic, Physical Layer (PHY) circuitry and/or logic, and/or any other circuitry and/or logic, configured to perform the functionality of message processors 128 and/or 158. Additionally or alternatively, one or more functionalities of message processors 128 and/or 158 may be implemented by logic, which may be executed by a machine and/or one or more processors, e.g., as described below.

In one example, message processors 128 and/or 158 may perform one or more functionalities of a NAN MAC configured to generate, process and/or handle one or more NAN messages, e.g., NAN Beacon frames and/or NAN Service Discovery frames.

In some demonstrative embodiments, at least part of the functionality of message processor 128 may be implemented as part of radio 114, and/or at least part of the functionality of message processor 158 may be implemented as part of radio 144.

In some demonstrative embodiments, at least part of the functionality of message processor 128 may be implemented as part of controller 124, and/or at least part of the functionality of message processor 158 may be implemented as part of controller 154.

In other embodiments, the functionality of message processor 128 may be implemented as part of any other element of device 102, and/or the functionality of message processor 158 may be implemented as part of any other element of device 104.

In some demonstrative embodiments, at least part of the functionality of NAN module 120, controller 124, and/or message processor 128 may be implemented by an integrated circuit, for example, a chip, e.g., a System in Chip (SoC). In one example, the chip or SoC may be configured to perform one or more functionalities of radio 114. For example, the chip or SoC may include one or more elements of NAN module 120, one or more elements of controller 124, one or more elements of message processor 128, and/or one or more elements of radio 114. In one example, NAN module 120, controller 124, message processor 128, and radio 114 may be implemented as part of the chip or SoC.

In some demonstrative embodiments, at least part of the functionality of NAN module 150, controller 154, and/or message processor 158 may be implemented by an integrated circuit, for example, a chip, e.g., a System in Chip (SoC). In one example, the chip or SoC may be configured to perform one or more functionalities of radio 144. For example, the chip or SoC may include one or more elements of NAN module 150, one or more elements of controller 154, one or more elements of message processor 158, and/or one or more elements of radio 144. In one example, NAN module 150, controller 154, message processor 158, and radio 144 may be implemented as part of the chip or SoC.

In some demonstrative embodiments, device 102 and/or device 140 may perform the functionality of a device or station, for example, an awareness networking device, a NAN device, a WiFi device, a WFD device, a ProSe device, a WLAN device and/or any other device, capable of discovering other devices according to a discovery protocol and/or scheme.

In some demonstrative embodiments, radios 114 and/or 144 may communicate over wireless communication medium 103 according to an awareness networking scheme, for example, a discovery scheme, for example, a WiFi Aware discovery scheme (“NAN discovery scheme”), and/or any other awareness networking and/or discovery scheme, e.g., as described below.

In some demonstrative embodiments, the awareness networking scheme, e.g., NAN, may enable applications to discover services in their close proximity. For example, the NAN technology may enable a low power service discovery, which may, for example, scale efficiently, e.g., in dense Wi-Fi environments.

In some demonstrative embodiments, a device, e.g., device 102 and/or device 140, may include one or more blocks and/or entities to perform network awareness functionality. For example, a device, e.g., device 102 and/or device 140, performing the functionality of a NAN device, may include a NAN MAC and/or a Discovery Engine (DE). In one example, controllers 124 and/or 154 may be configured to perform the functionality of the NAN MAC and/or the Discovery engine. In another example, the functionality of the NAN MAC and/or the Discovery engine may be performed by any other element and/or entity of device 102 and/or device 140.

In some demonstrative embodiments, the awareness networking scheme may include a discovery scheme or protocol, e.g., as described below.

In some demonstrative embodiments, device 102 and/or device 140 may perform a discovery process according to the awareness networking scheme, for example, to discover each other and/or to establish a wireless communication link, e.g., directional and/or high throughput wireless communication link and/or any other link.

In some demonstrative embodiments, device 102 and/or device 140 may be configured to enable time synchronization between device 102, device 140 and/or one or more other devices, e.g., performing the functionality of Wi-Fi stations (STAs), for example, such that STAs can discover each other more efficiently and/or quickly.

Some demonstrative embodiments are described below with respect to a NAN discovery scheme, and to NAN discovery frames of the NAN discovery scheme. However, in other embodiments, any other discovery scheme and/or discovery frames may be used.

In some demonstrative embodiments, the discovery scheme may include a plurality of contention-based discovery windows (DWs).

In some demonstrative embodiments, communication during the DWs may be configured to enable time synchronization between Wi-Fi stations (STAs), e.g., device 102 and/or device 140, so that STAs can find each other more efficiently during a DW.

In some demonstrative embodiments, devices of an awareness network, e.g. a NAN network, may form one or more clusters, e.g., in order to publish and/or subscribe for services. A NAN cluster may be defined by an Anchor Master (AM) (also referred to as a “NAN master device” or “anchor device”). In one example, the AM may include a NAN device, which has the highest rank in the NAN cluster.

In some demonstrative embodiments, NAN data exchange may be reflected by discovery frames, e.g., Publish, Subscribe and/or Follow-Up Service discovery frames (SDF). These frames may include action frames, which may be sent by a device that wishes to publish a service/application, and/or to subscribe to a published service/application at another end.

In some demonstrative embodiments, device 102 and/or device 140 may be configured to discover one another over a predefined communication channel (“the social channel”). In one example, the Channel 6 in the 2.4 GHz band may be defined as the NAN social channel. Any other channel may be used as the social channel.

In some demonstrative embodiments, device 102 and/or device 140 may transmit discovery frames, e.g., SDFs, during the plurality of DWs, e.g., over the social channel. For example the NAN AM may advertize the time of the DW, during which NAN devices may exchange SDFs.

In one example, device 102 and/or device 140 may transmit the discovery frames to discover each other, for example, to enable using the one or more services provided by applications 125, 126 and/or 145.

In some embodiments, the discovery frame may be transmitted as a group addressed, e.g., broadcast or multicast, discovery frame. In other embodiments, the discovery frame may be transmitted as any other type of frame.

In some demonstrative embodiments, a NAN cluster may be formed for devices in proximity, e.g., device 102 and/or device 140, such that, for example, devices in the same NAN cluster may follow the same time schedule, e.g., the discovery window schedule, for example, to facilitate cluster formation and/or achieve low power discovery operation.

In some demonstrative embodiments, after the discovery process, devices of the NAN cluster, e.g., device 102 and/or device 140, may perform peer-to-peer data transmission, for example, even without infrastructure, for example, an Access Point (AP), or Internet connectivity.

Some demonstrative embodiments may use the NAN technology to facilitate many-to-many or any-to-any data transmission, for example, even without infrastructure or Internet connectivity support.

In one example, Alice and Bob may have a WiFi and/or a NAN enabled device. Alice and Bob may be in an area without an infrastructure and/or Internet connectivity, e.g., rural areas or dense locations, e.g., a stadium. According to this example, once Alice discovers Bob in the proximity, Alice may like to establish a secure and direct connection with Bob.

In another example, two headless devices, e.g., Internet of Things (IoT) devices, for example, a motion sensor and a camera installed in a house, may discover each other and may establish a secure connection. According to this example, once motion is detected, the motion sensor may control the camera, for example, to start or stop recording. The two devices may automatically discover each other, and may establish a secure connection.

In some demonstrative embodiments, a secure NAN peer to peer data transmission, for example, with authenticity and/or confidentiality, may be required. However, some existing security frameworks, for example, in accordance with an IEEE 802.11 Specification, e.g., an 802.11i security framework, may not be designed for use, for example, without infrastructure or Internet connectivity support.

In some demonstrative embodiments, a security framework, for example, in accordance with an IEEE 802.11 Specification, e.g., an 802.11i security framework, may be enhanced, for example, for NAN peer-to-peer communication in a non-infrastructure or without Internet connectivity.

In some demonstrative embodiments, NAN applications may run on NAN devices, for example, with different computing and/or security capabilities.

Some demonstrative embodiments may provide, for example, a framework, which may be, for example, extensible to accommodate different security protocols and/or capabilities, for example, even without compromising a user experience.

For example, device 102 and/or device 140 may have different security and/or computing capabilities. According to this example, applications 125 and 145 may require a framework to accommodate the different security and/or computing capabilities of devices 102 and/or device 140, for example, to share data between applications 125 and 145.

Some demonstrative embodiments may provide, for example, a secure provisioning framework and/or protocol, which may, for example, operate on top of a security architecture, for example, a IEEE 802.11 security architecture, e.g., a 802.11i/WPA security architecture, to enable, for example, secure “peer to peer” or “device to device” NAN communication.

Some demonstrative embodiments may be configured, for example, to supplement a IEEE 802.11 security framework, e.g., a 802.11i/WPA security framework, which may be designed for infrastructure based WiFi connection, with an identity based authentication and/or dynamic key agreement, for example, with enhanced security, e.g., with perfect forward secrecy.

In some demonstrative embodiments, Elliptic curve based certificateless identity based authentication, e.g., as described in RFC 6507, and/or a Diffie Hellman key agreement protocol, may be used to enable NAN peers to establish a secure WLAN connection, e.g., a 802.11i/WPA connection, for example, by generating a security key, e.g., a 802.11i or a WPA Pairwise Master Key (PMK), on the NAN peers, e.g., for each 802.11i/WPA session.

In other embodiments, any other security protocol, authentication protocol, and/or key-agreement protocol, may be used.

Some demonstrative embodiments may be configured, for example, to provide an extensible solution framework to enable, for example, a NAN peer device, e.g., device 102 and/or device 140, to register with a service provider, and to acquire provisioning key information, for a selected security key agreement protocol and/or procedure, e.g., as described below.

Some demonstrative embodiments may be configured, for example, to provide an authenticated key agreement solution, which may be, for example, based on, and/or compatible with, one or more standard protocols.

Some demonstrative embodiments may be configured, for example, to simplify and/or to optimize the NAN device implementation requirements, for example, by enabling a NAN device, e.g., device 102 and/or device 140, to use the provisioning key information, for example, to generate a fresh 802.11i /WPA PMK, e.g., to bootstrap a 802.11i/WPA session between two NAN peers, for example, within a service provider community.

Some demonstrative embodiments may be configured, for example, to provide a solution, which may not, for example, incur overhead of an exiting certificate based solution, for example, in terms of protocol and/or storage on a device.

Some demonstrative embodiments may include a Dynamic Authenticated Key Agreement protocol, which may be configured, for example, to enable the NAN peers to derive a Pairwise master key (PMK), for example, to establish a 802.11i /WPA session, e.g., as described below.

In some demonstrative embodiments, device 102 and/or device 140 may be configured to perform one or more operations and/or communications, for example, during one or more phases, stages and/or procedures, for example, according to one or more protocols, algorithms, methods and/or schemes, e.g., as described below.

In some demonstrative embodiments, device 102 and/or device 140 may communicate one or more messages to establish a secure connection between device 102 and device 140, e.g., as describe below.

In some demonstrative embodiments, device 102 may discover NAN device 140, for example, according to a NAN discovery scheme.

In some demonstrative embodiments, device 102 may transmit to NAN device 140 a first message signed with a signing key of device 102.

In some demonstrative embodiments, a device, e.g., device 102, may sign a message using a signing key of the device, e.g., the signing key of device 102, by performing one or more operations and/or algorithms to generate, to produce, and/or to create a signature, e.g., a digital signature, which may be configured to enable another device, e.g., device 140, to verify and/or to authenticate an identity of the device based on the signature.

In one example, device 102 may sign the first message with the signing key of device 102, for example, by applying to the first message a cryptographic operation, e.g., an encryption operation, using the signing key of the device 102. A receiver of the first message, e.g., device 140, may be able to verify the identity of device 102, for example, based on the signature, e.g., using a public key.

In other embodiments, any additional or alternative operations may be performed to sign a message with a signing key.

In some demonstrative embodiments, the first message may include a first public security key of device 102, and a first public verification key device 102.

In some demonstrative embodiments, the first message may include a first user identifier of device 102, and a first nonce.

In some demonstrative embodiments, the nonce may include a random number, an arbitrary number, a time stamp, or the like.

In one example, message processor 128 may generate the first message, and transmitter 118 may transmit the first message to device 140.

In some demonstrative embodiments, device 140 may receive the first message from device 102.

In some demonstrative embodiments, controller 154 may process the first message received from device 102.

In some demonstrative embodiments, controller 154 may verify an identity of NAN device 102, for example, based on the first public verification key and a shared service public key.

In some demonstrative embodiments, device 140 may transmit a second message to device 102.

In some demonstrative embodiments, the second message may be signed with a signing key of device 140.

In some demonstrative embodiments, the second message may include a second public security key of device 140, and a second public verification key of device 140.

In some demonstrative embodiments, the second message may include a second user identifier of device 140, the first time stamp, and a second nonce.

In one example, message processor 158 may generate the second message, and transmitter 148 may transmit the second message to device 102.

In some demonstrative embodiments, the first and second public security keys may include Diffie-Hellman (DH) ephemeral keys.

In other embodiments, the first and second public security keys may include any other keys.

In some demonstrative embodiments, device 102 may receive the second message, e.g., via receiver 116.

In some demonstrative embodiments, controller 124 may process the second message, and may verify an identity of device 140, for example, based on the second public verification key and the shared service public key.

In some demonstrative embodiments, controller 124 may determine a session security key, for example, based on the first and second public security keys.

In one example, controller 124 may determine the session security key, for example, if the identity of device 140 is verified.

In some demonstrative embodiments, the session security key may include a Pairwise Master Key (PMK).

In other embodiments, the session security key may include any other key.

In some demonstrative embodiments, controller 124 may establish a secure session between device 102 and device 140, for example, using the session security key.

In one example, controller 124 may utilize the session security key as a PMK to bootstrap a security protocol, for example, an IEEE 80211i /WPA security protocol and/or any other protocol, to establish the secure session between device 102 and device 140.

In some demonstrative embodiments, a device, e.g., one of devices 102 and 140, may be configured to verify an identity of another device, e.g., another one of devices 102 and 140, for example, as part of a discovery process, e.g., between device 102 and device 140, e.g., as described below.

In one example, a first device, e.g., device 102, may verify an identity of a second device, e.g., device 140, for example, as part of a secure discovery process, e.g., between device 102 and device 140, e.g., as described below.

In one example, device 140 may be configured to verify an identity of device 102, for example, as part of the discovery process between device 102 and device 140.

In some demonstrative embodiments, device 102 may transmit a discovery message to discover device 140, e.g., as part of the discovery process.

In some demonstrative embodiments, the discovery message may include a secure discovery message, which may enable a receiver of the secure discovery message to verify an identity of a sender of the discovery message.

In some demonstrative embodiments, the discovery message transmitted by device 102 may include, or may be in a form of, an advertisement message, for example, to announce a presence of device 102.

In some demonstrative embodiments, the discovery message transmitted by device 102 may include, or may be in the form of, a solicitation message, for example, to solicit another device, e.g., device 140, to indicate it is present.

In some demonstrative embodiments, the discovery message may be signed by the signing key of device 102, and may include the first public verification key of device 102.

In some demonstrative embodiments, device 140 may receive the discovery message and controller 154 may process the discovery message.

In some demonstrative embodiments, controller 154 may verify an identity of device 102 based on the first public verification key and the shared service public key.

In some demonstrative embodiments, device 102 and/or device 140 may be configured to receive security information from a server.

In some demonstrative embodiments, device 102 and/or device 140 may be configured to perform one or more operations of a registration procedure (also referred to as “Phase 1”), for example, as part of a service registration, e.g., to obtain the security information.

In some demonstrative embodiments, device 102 and/or device 140 may be configured to register with the server, for example, to obtain provisioning key materials to bootstrap 80211i /WPA.

In some demonstrative embodiments, a user of a NAN capable device, e.g., a user of device 102 and/or device 140, may subscribe to a server, e.g., a cloud service provider, offering one or more NAN services, e.g., as described below.

In some demonstrative embodiments, upon successful subscription of the user, the NAN device may be provisioned with security information, for example, including key materials required by RFC 6507, e.g., Elliptic Curve Identity based or Certificateless authentication (also referred to as “ECCI”), and/or any other information.

In some demonstrative embodiments, system 100 may include a server 160 configured to provide the security information to device 102 and/or device 140.

In some demonstrative embodiments, server 160 may include a cloud server, e.g., a Cloud-based Provisioning Service (CPS), a web server, and/or any other server configured to provide provisioning, device registration, service management, and/or any other functionalities to device 102 and/or device 140.

In some demonstrative embodiments, server 160 may include at least one application and/or service 165 to which device 102 and/or device 140, and/or a user of device 102 and/or device 140, may be subscribed.

In some demonstrative embodiments, server 160 may be configured to provide to device 140, for example, the signing key of device 140, the public verification key of device 140, and/or the shared service public key.

In other embodiments, server 160 may be configured to provide to device 140 any other security information.

In some demonstrative embodiments, server 160 may be configured to provide to device 102, for example, the signing key of device 102, the public verification key of device 102, and/or the shared service public key, e.g., as described below.

In other embodiments, server 160 may be configured to provide to device 102 any other security information.

In some demonstrative embodiments, device 102 may send a registration request to server 160.

In some demonstrative embodiments, the registration request may include the user identifier of device 102.

In some demonstrative embodiments, message processor 128 may generate the registration request, and/or transmitter 118 may transmit the registration request to server 160.

In some demonstrative embodiments, server 160 may receive the registration request and may process the registration request.

In some demonstrative embodiments, server 160 may include a registration module 167, e.g., a “Service Registration Framework”, configured to allow a NAN device, e.g., device 102 and/or device 140, to register with application 165.

In some demonstrative embodiments, server 160 may send a response to device 102, e.g., in response to the registration request.

In some demonstrative embodiments, the response may include provisioning key information.

In some demonstrative embodiments, the provisioning key information may include Elliptic Curve Identity based Certificateless authentication (ECCI) key information.

In some demonstrative embodiments, the provisioning key information may include the signing key of device 102.

In some demonstrative embodiments, the provisioning key information may include the first public verification key of device 102.

In some demonstrative embodiments, the provisioning key information may include the shared service public key.

In some demonstrative embodiments, the shared service public key may include a key, which may be shared between NAN devices being subscribed with server 160, e.g., NAN devices subscribed with application 165. For example, the shared service public key may be shared with all devices subscribed with server 160.

In one example, the shared service public key may be shared between device 102 and device 140, for example, if device 102 and 140 are subscribed to application 165.

In some demonstrative embodiments, the first public verification key may be based on a user identifier of device 102 at server 160.

In one example, the user identifier of device 102 may include an identifier of a user, e.g., a “signing name” of the user, being used to register to application 165, an email address of the user, a username, and/or any other user identifier.

In another example, the user identifier of device 102 may include an identifier of device 102, e.g., a MAC address of device 102, and/or any other identifier of device 102, which is being used to identify device 102 at application 165.

In some demonstrative embodiments, device 102 may receive from server 160 the response including the provisioning key information.

In some demonstrative embodiments, controller 124 may store the provisioning key information in a storage, e.g., a secure storage.

In one example, controller 124 may store the provisioning key information in storage 195, for example, in a secure manner.

In another example, controller 124 may store the provisioning key information in any other secure and/or encrypted storage.

In some demonstrative embodiments, device 102 may use the provisioning key information to establish the secure session between devices 102 and 140, e.g., as described above.

In some demonstrative embodiments, device 140 may receive provisioning key information with respect to device 140, for example, in a similar manner as device 102. For example, device 140 may send to server 160 a registration request including a user identifier of device 140, for example, to receive the provisioning key information with respect to device 140.

In some demonstrative embodiments, device 140 may use the provisioning key information of device 140, for example, to establish the secure session between devices 102 and 140, e.g., as described above.

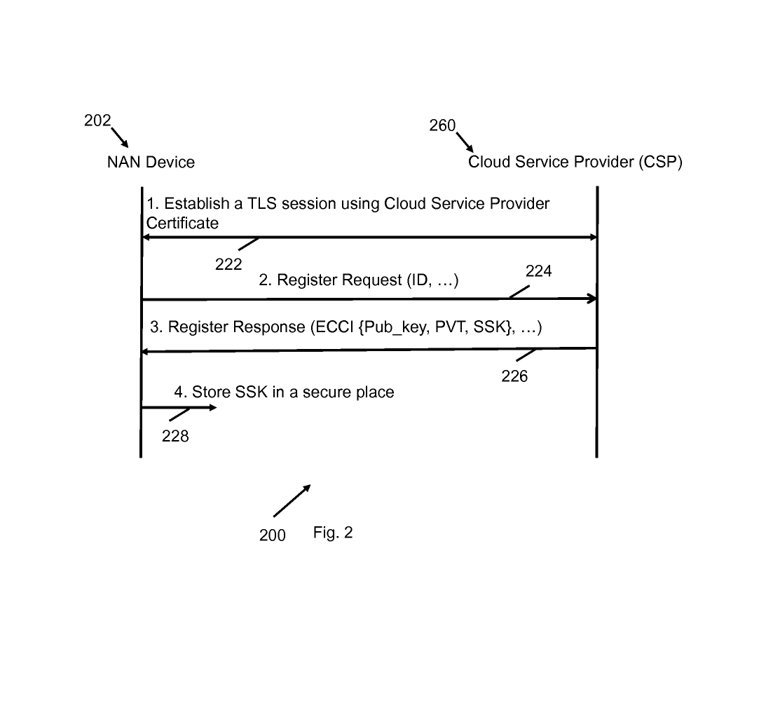

Reference is made to FIG. 2, which schematically illustrates a sequence diagram 200 of operations and interactions between a server 260 and a NAN device 202, in accordance with some demonstrative embodiments. For example, NAN device 202 may perform the functionality of device 102 and/or device 140 (FIG. 1), and/or server 260 may perform the functionality of server 160 (FIG. 1).

As shown in FIG. 2, in some demonstrative embodiments, NAN Device 202 may establish (222) a Transport Layer Security (TLS) session with server 160.

As shown in FIG. 2, in some demonstrative embodiments, NAN device 202 may transmit a Service Registration Request 224 to server 260. For example, NAN device 202 may send a registration request 224 to server 260, for example, in order to register with server 260 a user identity associated with NAN device 202.

In one example, device 102 (FIG. 1) may transmit registration request 224 to server 160 (FIG. 1), for example, to register device 102 (FIG. 1) at application 165 (FIG. 1), e.g., as described above.

In other embodiments, NAN device 202 may also send one or more other parameters and/or information to server 260.

As shown in FIG. 2, in some demonstrative embodiments, server 260 may transmit a service registration response 226 to device 202.

In some demonstrative embodiments, registration response 226 may include security information, for example, ECCI credentials to NAN device 202 and/or any other credentials, keys, and/or security information.

In one example, server 160 (FIG. 1) may transmit registration response 226 to device 102 (FIG. 1), for example, to provide the provisioning key information of device 102 (FIG. 1), e.g., as described above.

As shown in FIG. 2, in some demonstrative embodiments, NAN device 202 may be configured to store (228) the security information, e.g., the ECCI credentials.

In some demonstrative embodiments, the ECCI credentials, may include, for example, a shared service public key, a signing key, a public verification key, e.g., a public verification token (PVT), and/or any other credentials and/or information.

In some demonstrative embodiments, the ECCI credentials may include the shared service Public Key of server 260. This shared service Public Key may be, for example, shared among all NAN peers, e.g., being subscribed at server 260.

In some demonstrative embodiments, the ECCI credentials may include the Signing Key, e.g., an ECCI signing key (SSK), which may be tied to an identity of a user, which, for example, owns or uses NAN device 202.

In some demonstrative embodiments, NAN device 202 may be configured to store the ECCI SSK in a secure place.

In some demonstrative embodiments, the ECCI credentials may include the PVT, which may be tied to an identity of a user, which, for example, owns or uses NAN device 202.

In some demonstrative embodiments, a first NAN device, which may perform the functionality of a signer, e.g., device 102 (FIG. 1), may use the Signing Key, for example, to sign a message.

In some demonstrative embodiments, a second NAN device, which may perform the functionality of a verifier, e.g., device 140 (FIG. 1), may use the shared service public key, and the PVT of the signer, for example, to verify the signature of the message.

In some demonstrative embodiments, a NAN peer may perform the functionality of both the signer and the verifier, for example, to achieve mutual authentication.

In one example, device 102 (FIG. 1) may perform the functionality of the signer, for example, to enable device 140 (FIG. 1) to verify the identity of device 102 (FIG. 1); and/or device 102 (FIG. 1) may perform the functionality of the verifier, for example, to verify the identity of device 140 (FIG. 1).

In some demonstrative embodiments, device 102 and/or device 140 (FIG. 1) may be configured to perform one or more operations of an Authenticated Key Agreement procedure (also referred to as “Phase 2”), for example, to establish the secure session between devices 102 and 140 (FIG. 1), e.g., as described below.

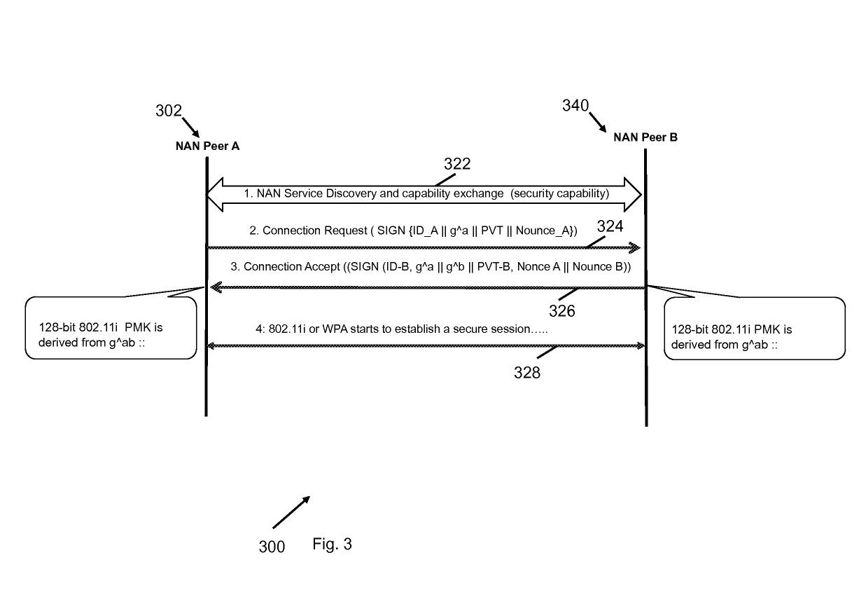

Reference is made to FIG. 3, which schematically illustrates a sequence diagram 300 of operations and interactions between a first NAN device 302 and a second NAN device 340, in accordance with some demonstrative embodiments. For example, NAN device 302 may perform the functionality of device 102 (FIG. 1), and/or NAN device 340 may perform the functionality of device 140 (FIG. 1).

In some demonstrative embodiments, one or more operations of sequence diagram 300 may be implemented, for example, to establish a secure session between devices 302 and 340.

In some demonstrative embodiments, the Authenticated Key Agreement procedure may include a discovery phase, for example, a NAN Discovery Phase.

In some demonstrative embodiments, as shown in FIG. 3, device 302 (“NAN peer A”) may perform a discovery and capability exchange 322 with a device 340 (“NAN peer B”), for example, to enable NAN devices 302 and 340 to discover one another, and to exchange security capability information of NAN device 302 and/or NAN device 340.

In some demonstrative embodiments, device 302 and device 340 may perform a secure discovery and capability exchange, for example, using a signing key, e.g., an ECCI signing key (SSK), of device 302 to verify the identity of device 302, and/or a signing key of device 340 to verify the identity of device 340, e.g., as described above.

As shown in FIG. 3, in some demonstrative embodiments device 302 may send a connection request 324 to device 340.

In some demonstrative embodiments, device 302 may choose a value, for example, a random value, denoted “a”, as a private security key of device 302, e.g., an ephemeral DH private key.

In some demonstrative embodiments, device 302 may compute a value, for example, g^{a}, as a public security key of device 302, e.g., an ephemeral DH public key.

In some demonstrative embodiments, device 302 may send connection request 324 including the following parameters:

{ID-A, PVT-A, ĝa, Nonce-A}

wherein ID-A denotes the user identifier of device 302, PVT-A denotes the PVT of device 302, and Nonce-A denotes a nonce generated by device 302.

In some demonstrative embodiments, connection request 324 may be signed by the signing key, e.g., the ECCI SSK, of device 302, which may be obtained during the service registration at server 260 (FIG. 2), e.g., as described above.

As shown in FIG. 3, in some demonstrative embodiments device 340 may send a connection accept 326 to device 302, e.g., in response to connection request 344.

In some demonstrative embodiments, device 340 may choose a value, for example, a random value, denoted “b”, as a private security key, e.g., an ephemeral DH private key.

In some demonstrative embodiments, device 340 may compute a value g^{b} as a public security key of device 340, e.g., an ephemeral DH public key.

In some demonstrative embodiments, device 340 may send connection accept 326 including the following parameters:

{ID-B, PVT-B, ĝb, Nonce_A, Nonce_B}

wherein ID-B denotes the user identifier of device 340, PVT-B denotes the PVT of device 340, and Nonce-B denotes a nonce generated be device 340.

In some demonstrative embodiments, connection accept 326 may be signed by the signing key, e.g., ECCI SSK, of device 340, which may be obtained during the service registration at server 260 (FIG. 2), e.g., as described above.

In some demonstrative embodiments, device 302 and/or device 340 may determine a session key based on the public security key of device 302, e.g., g^{a}, and the public security key of device 340, e.g., g^{b}.

For example, device 302 may determine the session key based on (g^{b})^{a}=g^{a}*^{b}, and/or device 340 may determine the session key based on (g^{a})^{b}=g^{b}*^{a}.

As shown in FIG. 3, in some demonstrative embodiments device 302 and device 340 may establish a secure session 328, e.g., by dynamically using the session key, for example, by performing a security protocol, e.g., by bootstrapping a IEEE 802.11i or WPA exchange, to establish secure session 328, and/or to complete key hierarchy derivation.

In some demonstrative embodiments, a NAN peer, e.g., device 302 and/or device 340, may use a local policy for creating a nonce, for example the Nonce-A and/or the Nonce-B, e.g., a timestamp, a counter, or the like.

In some demonstrative embodiments, the NAN peer may be configured to issue an appropriate reject message, for example, to stop the exchange of sequence 300, e.g., if an error occurs, for example, if a signature is not verified.

In one example, device 302 may issue a reject message to device 340, for example, if the signature of device 340 on connection accept 326 is not verified.

In some demonstrative embodiments, the NAN peer may use a suitable method to derive a PMK, e.g., an N-bit PMK, for example, based on the operations and interactions of sequence diagram 300. For example, the NAN peer may use a SHA256 (0x00, DH-Session-Key, 0x01), e.g., using low or upper 128-bits for 802.11i /WPA PMK.

In some demonstrative embodiments, the NAN peer may be configured to perform a registration to a service. During the registration to the service, the NAN peer may be provided with key materials, e.g., a signing key, from the server, e.g., for signing and proving the authenticity of messages of the NAN peer, e.g., as described above. The NAN peer may store the signing key in a secure place.

In some demonstrative embodiments, the NAN peer may use the signing key to achieve a secure discovery. For example, the signing key may be used by the NAN peer to sign a secure advertisement of existence of the NAN peer, e.g., “Bob is here”, and/or a secure solicitation of the NAN peer, e.g., “Are you there Bob?”.

In some demonstrative embodiments, once the NAN peer discovers another NAN peer, the NAN peer may use the signing key, e.g., with a Diffie Hellman protocol, to generate a PMK, which may be used, for example, to bootstrap a 802.11i protocol, for example, to establish a secure WiFi direct connection between the NAN peer and the other NAN peer, e.g., as described above.

In one example, although the Diffie Hellman protocol may be used to dynamically generate a shared key, the Diffie Hellman protocol may not be able to authenticate an identity of NAN peers. For example, a NAN peer “Alice” may use the Diffie Hellman protocol with another NAN peer, e.g., which may claims to be “Bob”, for example, to generate a shared key to protect communication between the NAN peer “Alice” and the NAN peer claiming to be “Bob”. However, the Diffie Hellman protocol may not enable the NAN peer “Alice” to verify whether the other NAN peer is indeed “Bob”. Adding authentication may solve this problem. For example, by verifying the signature of Bob, Alice may be assured that Alice is communicating with Bob, e.g., and not with another NAN peer that claims he is Bob, and vice a versa.

In some demonstrative embodiments, the combined use of ECCI-based authentication and DH key agreement, e.g., as described above, may be used in the context of any other communication network, system and/or technology.

In some demonstrative embodiments, one or more of the operations described herein with respect to NAN device may be performed, for example, by devices capable of one-to-one ProSe (Proximity Services) direct communication, and/or any other devices.

In one example, the combined use of ECCI-based authentication and the DH key agreement, e.g., as described above, may be used in the context of Rel-13 3GPP one-to-one ProSe direct communication over the PC5, e.g., UE-to-UE, reference point, for example, for ECCI-based authentication and Sakai-Kasahara Key Encryption (SAKKE) based key agreement, for example, when establishing a one-to-one communication over PC5.

In some demonstrative embodiments, devices 302 and 340 may perform security association, e.g., including mutual authentication and agreement of common key material between devices 302 and 340, e.g., as described above.

In some demonstrative embodiments, device 302 and/or device 340 may be configured to perform the mutual authentication using the ECCI (e.g., IETF RFC 6507) signature scheme, e.g., as described above.

In some demonstrative embodiments, device 302 and/or device 340 may be configured to generate the 802.11i /WPA Pairwise Master Key, e.g., the PMK, for example, using the combination of ECCI and Diffie Hellman protocols, e.g., as described above.

In some demonstrative embodiments, requirements of device 302 and/or device 340, for example, storage requirements, may be reduced, e.g., minimized, for example, by using the provisioning key information, which may enable to establish 802.11i /WPA secure communication to any NAN device within NAN devices being subscribed to server 260 (FIG. 2).

In some demonstrative embodiments, the session security key may be determined based on the combination of ECCI and Diffie Hellman protocols, e.g., as described above.

In other embodiments, the session security key may be determined based on any other security protocol.

In one example, the session security key may be determined using a SAKKE-based key agreement, e.g., as described below.

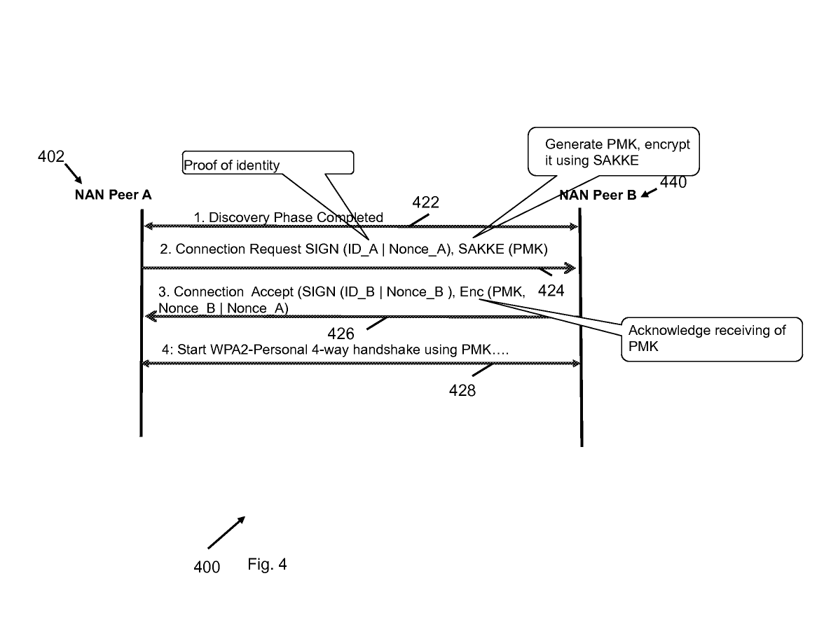

Reference is made to FIG. 4, which schematically illustrates a sequence diagram 400 of operations and interactions between a first NAN device 402 and a second NAN device 440, in accordance with some demonstrative embodiments. For example, NAN device 402 may perform the functionality of device 102 (FIG. 1), and/or NAN device 440 may perform the functionality of device 140 (FIG. 1).

In some demonstrative embodiments, one or more operations of sequence diagram 400 may be implemented, for example, to establish a secure session between devices 402 and 440, for example, using the SAKKE key agreement protocol.

In some demonstrative embodiments, the Authenticated Key Agreement procedure may include a discovery phase 422, for example, a NAN Discovery Phase.

In some demonstrative embodiments, as shown in FIG. 4, device 402 (“NAN peer A”) may perform a discovery and capability exchange 422 with a device 440 (“NAN peer B”), for example, to enable NAN devices 402 and 440 to discover one another, and to exchange security capability information of NAN device 402 and/or NAN device 440.

In some demonstrative embodiments, device 402 and device 440 may perform a secure discovery and capability exchange, for example, using a signing key, e.g., an ECCI signing key (SSK), of device 402 to verify the identity of device 402, and/or a signing key of device 440 to verify the identity of device 440, e.g., as described above.

As shown in FIG. 4, in some demonstrative embodiments device 402 may send a connection request 424 to device 440.

In some demonstrative embodiments, device 402 may send connection request 424 including the following parameters:

SIGN(ID_A|Nonce_A), SAKKE(PMK)

wherein ID-A denotes the user identifier of device 402, Nonce-A denotes a nonce generated by device 402, and PMK denotes a shared key generated by device 402, e.g., to bootstrap a WPA2-Personal for 802.11i authentication protocol, and encrypted by the SAKKE method, e.g., as described in RFC 6508.

In one example, the shared key may be encrypted using the user identifier of device 440 and the shared service public key, for example, a KMS Public Key, e.g., according to the SAKKE Method.

In some demonstrative embodiments, the ID-A and the Nonce_A may be signed by the signing key, e.g., the ECCI SSK, of device 402, which may be obtained during the service registration at server 260 (FIG. 2), e.g., as described above.

As shown in FIG. 4, in some demonstrative embodiments device 440 may send a connection accept 426 to device 402, e.g., in response to connection request 444.

In some demonstrative embodiments, device 440 may send connection accept 426 including the following parameters:

(SIGN(ID_B|Nonce_B), Enc(PMK, Nonce_B|Nonce_A)

wherein ID-B denotes the user identifier of device 440, Nonce-B denotes a nonce generated be device 440, and Enc denotes an Encryption function, e.g., an Advanced Encryption Standard Counter with CBC-MAC (AES-CCM) encryption function, or any other encryption function.

In one example, the encryption function may include two parameters, for example, a secret key for encryption, e.g., the PMK, and a payload of the encryption, e.g., a concatenation of the Nonce_A and the Nonce_B. The encryption function may enable, for example, to acknowledge receipt of the PMK, e.g., while using the Nonces for protocol freshness and/or replay attack mitigation.

In some demonstrative embodiments, the ID_B and the Nonce_B may be signed by the signing key, e.g., ECCI SSK, of device 440, which may be obtained during the service registration at server 260 (FIG. 2), e.g., as described above.

In some demonstrative embodiments, device 402 and/or device 440 may initiate a security protocol 428, e.g., by bootstrapping an IEEE 802.11i or WPA exchange, to establish a secure session between devices 402 and 440.

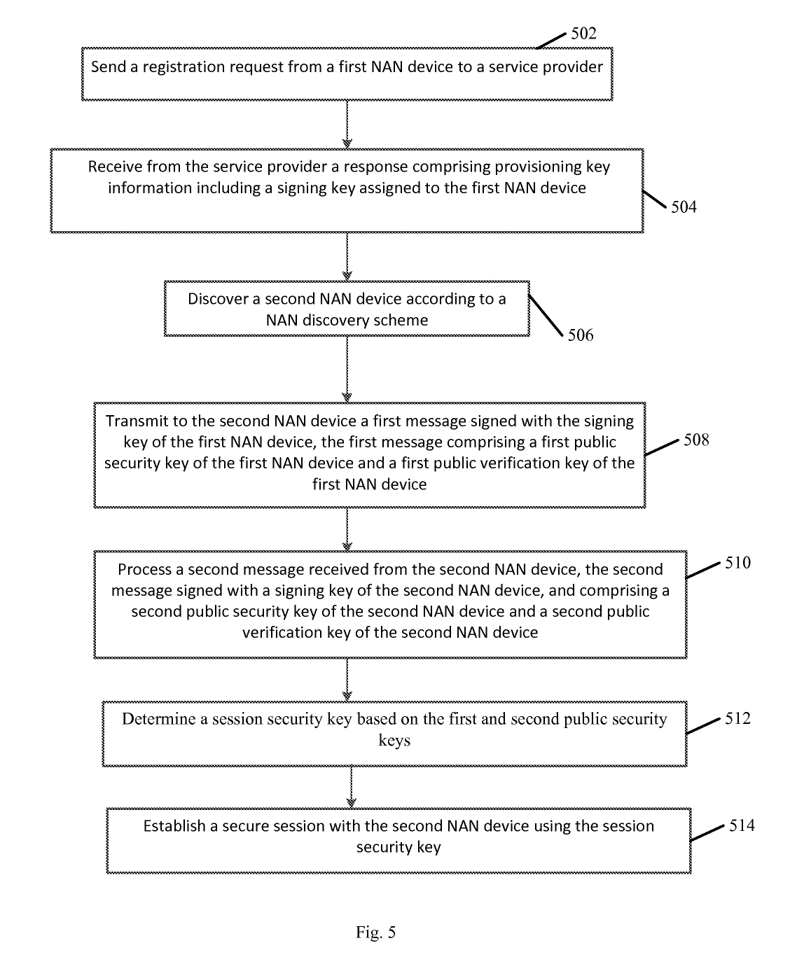

Reference is made to FIG. 5, which schematically illustrates a method of securing communication between wireless devices, in accordance with some demonstrative embodiments. For example, one or more of the operations of the method of FIG. 4 may be performed by one or more elements of a system, e.g., system 100 (FIG. 1); a server, e.g., server 160 (FIG. 1); a registration module, e.g., registration module 167 (FIG. 1); a device, e.g., wireless communication devices 102, and/or 140 (FIG. 1); a NAN module, e.g., NAN modules 120 and/or 150 (FIG. 1); a controller, e.g., controllers 124 and/or 154 (FIG. 1); a radio, e.g., radios 114 and/or 144 (FIG. 1); and/or a message processor, e.g., message processors 128 and/or 158 (FIG. 1).

As indicated at block 502, the method may include sending a registration request from a first NAN device to a service provider. For example, device 102 (FIG. 1) may send the registration request to server 160 (FIG. 1), e.g., as described above.

As indicated at block 504, the method may include receiving from the service provider a response may include provisioning key information including a signing key assigned to the first NAN device. For example, device 102 (FIG. 1) may receive from server 160 (FIG. 1) the provisioning key information including the signing key of device 102 (FIG. 1), e.g., as described above.

As indicated at block 506, the method may include discovering a second NAN device according to a NAN discovery scheme. For example, device 102 (FIG. 1) may discover a device 140 (FIG. 1), for example, according to the NAN discovery scheme, e.g., as described above.

As indicated at block 508, the method may include transmitting to the second NAN device a first message signed with the signing key of the first NAN device, the first message may include a first public security key of the first NAN device and a first public verification key of the first NAN device. For example, device 102 (FIG. 1) may transmit to device 140 (FIG. 1) the first message signed with the signing key of device 102 (FIG. 1), the first message including the first public security key of device 102 (FIG. 1) and the first public verification key of device 102 (FIG. 1), e.g., as described above.

As indicated at block 510, the method may include processing a second message received from the second NAN device, the second message signed with a signing key of the second NAN device, and may include a second public security key of the second NAN device and a second public verification key of the second NAN device. For example, device 102 (FIG. 1) may process the second message received from device 140 (FIG. 1) the second message signed with the signing key of device 140 (FIG. 1), the second message including the second public security key of device 140 (FIG. 1) and the second public verification key of device 140 (FIG. 1), e.g., as described above.

As indicated at block 512, the method may include determining a session security key based on the first and second public security keys. For example, controller 124 (FIG. 1) may determine the session security key, for example, based on the first and second public security keys, e.g., as described above.

In one example, the first public security key may be included as part of the first message, which may be signed by the signing key of device 102 (FIG. 1); and/or the second public security key may be included as part of the second message, which may be signed by the signing key of device 140 (FIG. 1).

As indicated at block 514, the method may include establishing a secure session with the second NAN device using the session security key. For example, device 102 (FIG. 1) may establish the secure session with device 140 (FIG. 1) using the session security key, e.g., as described above.

In one example, device 102 (FIG. 1) may utilize the session security key, for example, to initiate an 802.11i /WPA protocol to establish the secure session with device 140 (FIG. 1).

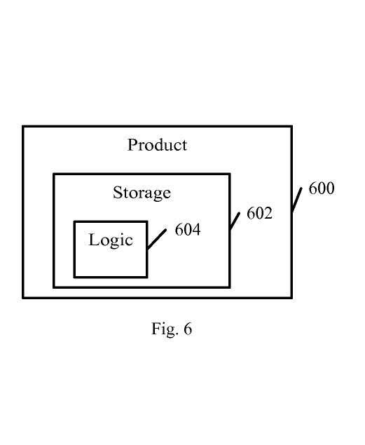

Reference is made to FIG. 6, which schematically illustrates a product of manufacture 500, in accordance with some demonstrative embodiments. Product 600 may include a non-transitory machine-readable storage medium 602 to store logic 604, which may be used, for example, to perform at least part of the functionality of devices 102 and/or 140 (FIG. 1), server 160 (FIG. 1), registration module 167 (FIG. 1), radios 114 and/or 144 (FIG. 1), transmitters 118 and/or 148 (FIG. 1), receivers 116 and/or 146 (FIG. 1), NAN modules 120 and/or 150 (FIG. 1), interfaces 122 and/or 152 (FIG. 1), controllers 124 and/or 144 (FIG. 1), and/or message processors 128 and/or 158 (FIG. 1), and/or to perform one or more operations of FIGS. 2, 3, 4 and/or 5. The phrase “non-transitory machine-readable medium” is directed to include all computer-readable media, with the sole exception being a transitory propagating signal.

In some demonstrative embodiments, product 600 and/or machine-readable storage medium 602 may include one or more types of computer-readable storage media capable of storing data, including volatile memory, non-volatile memory, removable or non-removable memory, erasable or non-erasable memory, writeable or re-writeable memory, and the like. For example, machine-readable storage medium 602 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 604 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 604 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

### EXAMPLES

The following examples pertain to further embodiments.

Example 1 includes an apparatus comprising logic and circuitry configured to cause a first Neighbor Awareness Networking (NAN) device to discover a second NAN device according to a NAN discovery scheme; transmit to the second NAN device a first message signed with a signing key of the first NAN device, the first message comprising a first public security key of the first NAN device and a first public verification key of the first NAN device; process a second message received from the second NAN device, the second message signed with a signing key of the second NAN device and comprising a second public security key of the second NAN device and a second public verification key of the second NAN device; determine a session security key, based on the first and second public security keys; and establish a secure session with the second NAN device using the session security key.

Example 2 includes the subject matter of Example 1, and optionally, being configured to cause the first NAN device to verify an identity of the second NAN device, based on the second public verification key and a shared service public key.

Example 3 includes the subject matter of Example 1 or 2, and optionally, wherein the first message comprises a first user identifier of the first NAN device and a first nonce, and the second message comprises a second user identifier of the second NAN device, the first nonce, and a second nonce.

Example 4 includes the subject matter of any one of Examples 1-3, and optionally, being configured to cause the first NAN device to transmit a discovery message to discover the second NAN device, the discovery message signed by the signing key of the first NAN device, and comprising the first public verification key.

Example 5 includes the subject matter of any one of Examples 1-4, and optionally, being configured to cause the first NAN device to process a discovery message received from the second NAN device, the discovery message signed by the signing key of the second NAN device and comprising the second public verification key, and to verify an identity of the second NAN device based on the second public verification key and a shared service public key.

Example 6 includes the subject matter of any one of Examples 1-5, and optionally, being configured to cause the first NAN device to send a registration request to a service provider; and receive from the service provider a response comprising provisioning key information, which comprises the signing key assigned to the first NAN device.

Example 7 includes the subject matter of Example 6, and optionally, wherein the registration request comprises a user identifier of the first NAN device.

Example 8 includes the subject matter of Example 6 or 7, and optionally, wherein the provisioning key information comprises the first public verification key, and a shared service public key shared between NAN devices being subscribed with the service provider.

Example 9 includes the subject matter of any one of Examples 6-8, and optionally, wherein the first public verification key is based on a user identifier of the first NAN device at the service provider.

Example 10 includes the subject matter of any one of Examples 6-9, and optionally, wherein the provisioning key information comprises Elliptic Curve Identity based Certificateless authentication (ECCI) key information.

Example 11 includes the subject matter of any one of Examples 1-10, and optionally, wherein the session security key comprises a Pairwise Master Key (PMK).

Example 12 includes the subject matter of any one of Examples 1-11, and optionally, wherein the first and second public security keys comprise Diffie-Hellman (DH) ephemeral keys.

Example 13 includes the subject matter of any one of Examples 1-12, and optionally, comprising a radio to communicate with the second NAN device.

Example 14 includes the subject matter of any one of Examples 1-13, and optionally, comprising one or more antennas, a memory, and a processor.

Example 15 includes a system comprising a first Neighbor Awareness Networking (NAN) device, the first NAN device comprising one or more antennas; a memory; a processor; and a NAN module to discover a second NAN device according to a NAN discovery scheme; to transmit to the second NAN device a first message signed with a signing key of the first NAN device, the first message comprising a first public security key of the first NAN device and a first public verification key of the first NAN device; to process a second message received from the second NAN device, the second message signed with a signing key of the second NAN device, and comprising a second public security key of the second NAN device and a second public verification key of the second NAN device; to determine a session security key, based on the first and second public security keys; and to establish a secure session with the second NAN device using the session security key.

Example 16 includes the subject matter of Example 15, and optionally, wherein the first NAN device is to verify an identity of the second NAN device, based on the second public verification key and a shared service public key.

Example 17 includes the subject matter of Example 15 or 16, and optionally, wherein the first message comprises a first user identifier of the first NAN device and a first nonce, and the second message comprises a second user identifier of the second NAN device, the first nonce, and a second nonce.

Example 18 includes the subject matter of any one of Examples 15-17, and optionally, wherein the first NAN device is to transmit a discovery message to discover the second NAN device, the discovery message signed by the signing key of the first NAN device, and comprising the first public verification key.

Example 19 includes the subject matter of any one of Examples 15-18, and optionally, wherein the first NAN device is to process a discovery message received from the second NAN device, the discovery message signed by the signing key of the second NAN device and comprising the second public verification key, and to verify an identity of the second NAN device based on the second public verification key and a shared service public key.

Example 20 includes the subject matter of any one of Examples 15-19, and optionally, wherein the first NAN device is to send a registration request to a service provider; and receive from the service provider a response comprising provisioning key information, which comprises the signing key assigned to the first NAN device.

Example 21 includes the subject matter of Example 20, and optionally, wherein the registration request comprises a user identifier of the first NAN device.

Example 22 includes the subject matter of Example 20 or 21, and optionally, wherein the provisioning key information comprises the first public verification key, and a shared service public key shared between NAN devices being subscribed with the service provider.

Example 23 includes the subject matter of any one of Examples 20-22, and optionally, wherein the first public verification key is based on a user identifier of the first NAN device at the service provider.

Example 24 includes the subject matter of any one of Examples 20-23, and optionally, wherein the provisioning key information comprises Elliptic Curve Identity based Certificateless authentication (ECCI) key information.

Example 25 includes the subject matter of any one of Examples 15-24, and optionally, wherein the session security key comprises a Pairwise Master Key (PMK).

Example 26 includes the subject matter of any one of Examples 15-25, and optionally, wherein the first and second public security keys comprise Diffie-Hellman (DH) ephemeral keys.

Example 27 includes the subject matter of any one of Examples 15-26, and optionally, wherein the first NAN device comprises a radio to communicate with the second NAN device.

Example 28 includes a method to be performed at a first Neighbor Awareness Networking (NAN) device, the method comprising discovering a second NAN device according to a NAN discovery scheme; transmitting to the second NAN device a first message signed with a signing key of the first NAN device, the first message comprising a first public security key of the first NAN device and a first public verification key of the first NAN device; processing a second message received from the second NAN device, the second message signed with a signing key of the second NAN device, and comprising a second public security key of the second NAN device and a second public verification key of the second NAN device; determining a session security key based on the first and second public security keys; and establishing a secure session with the second NAN device using the session security key.

Example 29 includes the subject matter of Example 28, and optionally, comprising verifying an identity of the second NAN device, based on the second public verification key and a shared service public key.

Example 30 includes the subject matter of Example 28 or 29, and optionally, wherein the first message comprises a first user identifier of the first NAN device and a first nonce, and the second message comprises a second user identifier of the second NAN device, the first nonce, and a second nonce.

Example 31 includes the subject matter of any one of Examples 28-30, and optionally, comprising transmitting a discovery message to discover the second NAN device, the discovery message signed by the signing key of the first NAN device, and comprising the first public verification key.

Example 32 includes the subject matter of any one of Examples 28-31, and optionally, comprising processing a discovery message received from the second NAN device, the discovery message signed by the signing key of the second NAN device and comprising the second public verification key, and verifying an identity of the second NAN device based on the second public verification key and a shared service public key.

Example 33 includes the subject matter of any one of Examples 28-32, and optionally, comprising sending a registration request to a service provider; and receiving from the service provider a response comprising provisioning key information, which comprises the signing key assigned to the first NAN device.

Example 34 includes the subject matter of Example 33, and optionally, wherein the registration request comprises a user identifier of the first NAN device.

Example 35 includes the subject matter of Example 33 or 34, and optionally, wherein the provisioning key information comprises the first public verification key, and a shared service public key shared between NAN devices being subscribed with the service provider.

Example 36 includes the subject matter of any one of Examples 33-35, and optionally, wherein the first public verification key is based on a user identifier of the first NAN device at the service provider.

Example 37 includes the subject matter of any one of Examples 33-36, and optionally, wherein the provisioning key information comprises Elliptic Curve Identity based Certificateless authentication (ECCI) key information.

Example 38 includes the subject matter of any one of Examples 28-37, and optionally, wherein the session security key comprises a Pairwise Master Key (PMK).

Example 39 includes the subject matter of any one of Examples 28-38, and optionally, wherein the first and second public security keys comprise Diffie-Hellman (DH) ephemeral keys.

Example 40 includes a product comprising one or more tangible computer-readable non-transitory storage media comprising computer-executable instructions operable to, when executed by at least one computer processor, enable the at least one computer processor to implement one or more operations at a first Neighbor Awareness Networking (NAN) device, the operations comprising discovering a second NAN device according to a NAN discovery scheme; transmitting to the second NAN device a first message signed with a signing key of the first NAN device, the first message comprising a first public security key of the first NAN device and a first public verification key of the first NAN device; processing a second message received from the second NAN device, the second message signed with a signing key of the second NAN device, and comprising a second public security key of the second NAN device and a second public verification key of the second NAN device; determining a session security key based on the first and second public security keys; and establishing a secure session with the second NAN device using the session security key.

Example 41 includes the subject matter of Example 40, and optionally, wherein the operations comprise verifying an identity of the second NAN device, based on the second public verification key and a shared service public key.

Example 42 includes the subject matter of Example 40 or 41, and optionally, wherein the first message comprises a first user identifier of the first NAN device and a first nonce, and the second message comprises a second user identifier of the second NAN device, the first nonce, and a second nonce.

Example 43 includes the subject matter of any one of Examples 40-42, and optionally, wherein the operations comprise transmitting a discovery message to discover the second NAN device, the discovery message signed by the signing key of the first NAN device, and comprising the first public verification key.

Example 44 includes the subject matter of any one of Examples 40-43, and optionally, wherein the operations comprise processing a discovery message received from the second NAN device, the discovery message signed by the signing key of the second NAN device and comprising the second public verification key, and verifying an identity of the second NAN device based on the second public verification key and a shared service public key.

Example 45 includes the subject matter of any one of Examples 40-44, and optionally, wherein the operations comprise sending a registration request to a service provider; and receiving from the service provider a response comprising provisioning key information, which comprises the signing key assigned to the first NAN device.

Example 46 includes the subject matter of Example 45, and optionally, wherein the registration request comprises a user identifier of the first NAN device.

Example 47 includes the subject matter of Example 45 or 46, and optionally, wherein the provisioning key information comprises the first public verification key, and a shared service public key shared between NAN devices being subscribed with the service provider.

Example 48 includes the subject matter of any one of Examples 45-47, and optionally, wherein the first public verification key is based on a user identifier of the first NAN device at the service provider.

Example 49 includes the subject matter of any one of Examples 45-48, and optionally, wherein the provisioning key information comprises Elliptic Curve Identity based Certificateless authentication (ECCI) key information.

Example 50 includes the subject matter of any one of Examples 40-49, and optionally, wherein the session security key comprises a Pairwise Master Key (PMK).

Example 51 includes the subject matter of any one of Examples 40-50, and optionally, wherein the first and second public security keys comprise Diffie-Hellman (DH) ephemeral keys.

Example 52 includes an apparatus of wireless communication by a first Neighbor Awareness Networking (NAN) device, the apparatus comprising means for discovering a second NAN device according to a NAN discovery scheme; means for transmitting to the second NAN device a first message signed with a signing key of the first NAN device, the first message comprising a first public security key of the first NAN device and a first public verification key of the first NAN device; means for processing a second message received from the second NAN device, the second message signed with a signing key of the second NAN device, and comprising a second public security key of the second NAN device and a second public verification key of the second NAN device; means for determining a session security key based on the first and second public security keys; and means for establishing a secure session with the second NAN device using the session security key.

Example 53 includes the subject matter of Example 52, and optionally, comprising means for verifying an identity of the second NAN device, based on the second public verification key and a shared service public key.

Example 54 includes the subject matter of Example 52 or 53, and optionally, wherein the first message comprises a first user identifier of the first NAN device and a first nonce, and the second message comprises a second user identifier of the second NAN device, the first nonce, and a second nonce.

Example 55 includes the subject matter of any one of Examples 52-54, and optionally, comprising means for transmitting a discovery message to discover the second NAN device, the discovery message signed by the signing key of the first NAN device, and comprising the first public verification key.

Example 56 includes the subject matter of any one of Examples 52-55, and optionally, comprising means for processing a discovery message received from the second NAN device, the discovery message signed by the signing key of the second NAN device and comprising the second public verification key, and verifying an identity of the second NAN device based on the second public verification key and a shared service public key.

Example 57 includes the subject matter of any one of Examples 52-56, and optionally, comprising means for sending a registration request to a service provider; and means for receiving from the service provider a response comprising provisioning key information, which comprises the signing key assigned to the first NAN device.

Example 58 includes the subject matter of Example 57, and optionally, wherein the registration request comprises a user identifier of the first NAN device.

Example 59 includes the subject matter of Example 57 or 58, and optionally, wherein the provisioning key information comprises the first public verification key, and a shared service public key shared between NAN devices being subscribed with the service provider.

Example 60 includes the subject matter of any one of Examples 57-59, and optionally, wherein the first public verification key is based on a user identifier of the first NAN device at the service provider.

Example 61 includes the subject matter of any one of Examples 57-60, and optionally, wherein the provisioning key information comprises Elliptic Curve Identity based Certificateless authentication (ECCI) key information.

Example 62 includes the subject matter of any one of Examples 52-61, and optionally, wherein the session security key comprises a Pairwise Master Key (PMK).

Example 63 includes the subject matter of any one of Examples 52-62, and optionally, wherein the first and second public security keys comprise Diffie-Hellman (DH) ephemeral keys.

Functions, operations, components and/or features described herein with reference to one or more embodiments, may be combined with, or may be utilized in combination with, one or more other functions, operations, components and/or features described herein with reference to one or more other embodiments, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising logic and circuitry configured to cause a first Neighbor Awareness Networking (NAN) device to:
discover a second NAN device according to a NAN discovery scheme;
transmit to the second NAN device a first message signed with a signing key of the first NAN device, the first message comprising a first public security key of the first NAN device and a first public verification key of the first NAN device;
process a second message received from the second NAN device, the second message signed with a signing key of the second NAN device and comprising a second public security key of the second NAN device and a second public verification key of the second NAN device;
determine a session security key, based on the first and second public security keys; and
establish a secure session with the second NAN device using the session security key.

2. The apparatus of claim 1 being configured to cause the first NAN device to verify an identity of the second NAN device, based on said second public verification key and a shared service public key.

3. The apparatus of claim 1, wherein the first message comprises a first user identifier of said first NAN device and a first nonce, and the second message comprises a second user identifier of said second NAN device, the first nonce, and a second nonce.

4. The apparatus of claim 1 being configured to cause the first NAN device to transmit a discovery message to discover said second NAN device, the discovery message signed by the signing key of the first NAN device, and comprising the first public verification key.

5. The apparatus of claim 1 being configured to cause the first NAN device to process a discovery message received from the second NAN device, the discovery message signed by the signing key of the second NAN device and comprising the second public verification key, and to verify an identity of the second NAN device based on said second public verification key and a shared service public key.

6. The apparatus of claim 1 being configured to cause the first NAN device to:
send a registration request to a service provider; and
receive from the service provider a response comprising provisioning key information, which comprises the signing key assigned to the first NAN device.

7. The apparatus of claim 6, wherein the registration request comprises a user identifier of said first NAN device.

8. The apparatus of claim 6, wherein the provisioning key information comprises said first public verification key, and a shared service public key shared between NAN devices being subscribed with said service provider.

9. The apparatus of claim 6, wherein said first public verification key is based on a user identifier of said first NAN device at said service provider.

10. The apparatus of claim 6, wherein the provisioning key information comprises Elliptic Curve Identity based Certificateless authentication (ECCI) key information.

11. The apparatus of claim 1, wherein the session security key comprises a Pairwise Master Key (PMK).

12. The apparatus of claim 1, wherein said first and second public security keys comprise Diffie-Hellman (DH) ephemeral keys.

13. The apparatus of claim 1 comprising a radio to communicate with said second NAN device.

14. The apparatus of claim 1 comprising one or more antennas, a memory, and a processor.

15. A system comprising a first Neighbor Awareness Networking (NAN) device, the first NAN device comprising:
one or more antennas;
a memory;
a processor; and
a NAN module to discover a second NAN device according to a NAN discovery scheme; to transmit to the second NAN device a first message signed with a signing key of the first NAN device, the first message comprising a first public security key of the first NAN device and a first public verification key of the first NAN device; to process a second message received from the second NAN device, the second message signed with a signing key of the second NAN device, and comprising a second public security key of the second NAN device and a second public verification key of the second NAN device; to determine a session security key, based on the first and second public security keys; and to establish a secure session with the second NAN device using the session security key.

16. The system of claim 15, wherein the first NAN device is to verify an identity of the second NAN device, based on said second public verification key and a shared service public key.

17. The system of claim 15, wherein the first NAN device is to:
send a registration request to a service provider; and
receive from the service provider a response comprising provisioning key information, which comprises the signing key assigned to the first NAN device.

18. A method to be performed at a first Neighbor Awareness Networking (NAN) device, the method comprising:
discovering a second NAN device according to a NAN discovery scheme;
transmitting to the second NAN device a first message signed with a signing key of the first NAN device, the first message comprising a first public security key of the first NAN device and a first public verification key of the first NAN device;
processing a second message received from the second NAN device, the second message signed with a signing key of the second NAN device, and comprising a second public security key of the second NAN device and a second public verification key of the second NAN device;
determining a session security key based on the first and second public security keys; and
establishing a secure session with the second NAN device using the session security key.

19. The method of claim 18 comprising verifying an identity of the second NAN device, based on said second public verification key and a shared service public key.

20. The method of claim 18 comprising:
sending a registration request to a service provider; and
receiving from the service provider a response comprising provisioning key information, which comprises the signing key assigned to the first NAN device.

21. A product comprising one or more tangible computer-readable non-transitory storage media comprising computer-executable instructions operable to, when executed by at least one computer processor, enable the at least one computer processor to implement one or more operations at a first Neighbor Awareness Networking (NAN) device, the operations comprising:
discovering a second NAN device according to a NAN discovery scheme;
transmitting to the second NAN device a first message signed with a signing key of the first NAN device, the first message comprising a first public security key of the first NAN device and a first public verification key of the first NAN device;
processing a second message received from the second NAN device, the second message signed with a signing key of the second NAN device, and comprising a second public security key of the second NAN device and a second public verification key of the second NAN device;
determining a session security key based on the first and second public security keys; and
establishing a secure session with the second NAN device using the session security key.

22. The product of claim 21, wherein the operations comprise verifying an identity of the second NAN device, based on said second public verification key and a shared service public key.

23. The product of claim 21, wherein the first message comprises a first user identifier of said first NAN device and a first nonce, and the second message comprises a second user identifier of said second NAN device, the first nonce, and a second nonce.

24. The product of claim 21, wherein the operations comprise transmitting a discovery message to discover said second NAN device, the discovery message signed by the signing key of the first NAN device, and comprising the first public verification key.

25. The product of claim 21, wherein the operations comprise:
sending a registration request to a service provider; and
receiving from the service provider a response comprising provisioning key information, which comprises the signing key assigned to the first NAN device.
